(19) United States
(12) Patent Application Publication
(10) Pub. No.: US 2016/0221537 A1
(43) Pub. Date: Aug. 4, 2016

(54) WIPER SYSTEM FOR MOTOR VEHICLES

(71) Applicants: Hyundai Motor Company, Seoul (KR); Kia Motors Corporation, Seoul (KR)

(72) Inventors: Jin Hee LEE, Seoul (KR); Young Sub OH, Suwon-si (KR); Bock Cheol LEE, Suwon-si (KR); Nak Kyoung KONG, Seongnam-si (KR); Hyun Sub KIM, Seoul (KR)

(73) Assignees: Hyundai Motor Company, Seoul (KR); Kia Motors Corporation, Seoul (KR)

(21) Appl. No.: 14/864,579

(22) Filed: Sep. 24, 2015

(30) Foreign Application Priority Data
Feb. 3, 2015 (KR) 10-2015-0016472

(51) Int. Cl. B60S 1/24; B60S 1/34

(52) U.S. Cl. CPC B60S 1/245; B60S 1/3431

(57) ABSTRACT

A wiper system for motor vehicles may include a crank arm configured to be rotated by a wiper driving motor, a first link member connected to a first end of the crank arm to be linked with the crank arm, a third link member connected through a first hinge to be linked with the first link member and a second link member of which a first end is connected to the third link member through a second hinge, a lever member in which a first end is pivotably connected to a third hinge provided at a second end of the second link member and a driver's seat wiper arm mounting support shaft is pivotably provided at a second end, and a support shaft for mounting a passenger's seat wiper arm provided at a first end of the third link member of which one end is connected to the first hinge.

### CROSS-REFERENCE TO RELATED APPLICATION

The present application claims priority to Korean Patent Application No. 10-2015-0016472 filed Feb. 3, 2015, the entire contents of which is incorporated herein for all purposes by this reference.

### BACKGROUND OF THE INVENTION

1. Field of the Invention

The present invention relates to a wiper system for vehicles, and particularly, to a wiper system for vehicles which can increase a wiping area by deploying a pivot position of a wiper arm adjacent to a lower end of a windshield glass and has an enhanced structure for pivotably mounting the wiper arm.

2. Description of Related Art

In general, a wiper system that wipes a windshield glass is provided on the windshield glass of a vehicle to secure a view covered by rain or snow and the wiper system is generally installed at each of a driver's seat and a passenger's seat and a wiper blade is mounted on a wiper arm driven by a motor to wipe the windshield in an arc shape.

The wiper arm is generally mounted between a vehicle hood and the windshield glass to pivot, and as a result, a shape, a layout, and a structure of the wiper system have been enhanced to increase the wiping area as well as enhancing an exterior of the vehicle.

With an effort to enhance the structure of the wiper system, prior art discloses a wiper arm having a shape suitable for an outer shape and a lower connector of a vehicle windshield by allowing a wiper arm joint and a wiper rod of the wiper system to have the arc shape.

Further, prior art discloses a wiper system including a link member 2 that receives drive force of a wiper motor 1 to reciprocate, a link lever 3 that is connected to the link member to pivot and a pivot shaft 4 with a serration portion fixed to the link lever 3, a lever member 5 fixed to the other end of the pivot shaft, and a wiper arm support shaft 6 fixed to a lever portion to pivot from a shaft core of the pivot shaft, as schematically illustrated in FIG. 1 and FIG. 2.

However, in a passenger's seat wiper arm mounting structure of the wiper system of the previously described prior art, the pivot shaft 4 is fixed, and as a result, the lever member 5 on which the wiper arm is mounted, the pivot shaft 4 in which the serration portion is formed at both ends, and the link member 2 to which the drive force of the motor is transferred are coupled. Therefore, the structure is complicated and manufacturing cost increases.

Further, the support shaft 6 on which the wiper arm is mounted is fixed in a rivet method in the lever member 5 and as a usage period elapses, the pivot shaft becomes loose.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a wiper system for vehicles that integrates a link member and a lever for driving a passenger's seat wiper arm into one component and enhances a fastening structure of a support shaft for mounting an arm on an end of the one component so as to solve the problem associated with a structure for pivotably mounting a vehicle wiper arm in the related art.

According to various aspects of the present invention, a wiper system for motor vehicles may include a crank arm configured to be rotated by a wiper driving motor, a first link member connected to a first end of the crank arm to be linked with the crank arm, a third link member connected through a first hinge to be linked with the first link member and a second link member of which a first end is connected to the third link member through a second hinge, a lever member in which a first end is pivotably connected to a third hinge provided at a second end of the second link member and a driver's seat wiper arm mounting support shaft is pivotably provided at a second end, and a support shaft for mounting a passenger's seat wiper arm provided at a first end of the third link member of which one end is connected to the first hinge, in which the third link member may be integrally formed to include an upper end portion connected with the first link member linked with the crank arm through the first hinge, a middle portion connected to a first bracket through a fourth hinge as a pivot center shaft, and a lower end portion to which the passenger's seat wiper arm support shaft is fixed.

In cleaning operations of a driver's seat wiper and a passenger's seat wiper that clean a curved portion of a windshield glass formed by a curved surface, the upper end portion, the middle portion, and the lower end portion may be configured to be bent at predetermined different heights in order to adjust a height of a movement plane so that the upper end portion, the middle portion, and the lower end portion of the third link member move on a plane on which the crank arm and the upper end portion of the third link member are at least close and the middle portion that pivots around the hinge moves on a plane at least close to the lever member so as to prevent an excessive angle displacement at the first and third hinges of the second link member and the third link member.

In the third link member, the support shaft on which a passenger's seat arm is pivotably mounted so as to increase a rotary moment around the first hinge provided on a top may be provided at a location that extends from the fourth hinge of the middle portion.

In the support shaft, a fixation end portion penetrates the third link member, a support portion of which a diameter is enlarged may be formed at a position spaced inside from the fixation end portion by a thickness of the third link member, and the support portion may be configured to be deployed on a top of the third link member and the fixation end portion penetrating the third link member may be fixed to the third link member in a rivet fixation scheme.

In the third link member, the upper end portion at which the first hinge is provided, the middle portion at which the fourth hinge as a rotational center shaft is provided, and the lower end portion with the support shaft on which the passenger's driver wiper arm is mounted may be configured to be sequentially bent with heights being increased.

The third link member may be bent so that the middle portion at which the fourth hinge is provided is positioned below the upper end portion at which the first hinge is provided and the lower end portion at which the support shaft is provided is configured to be deployed at a highest location.

The first and second link members including and the lever member may be configured to be deployed in a cowl box below a windshield glass, while the driver's seat and passenger's seat wiper arm mounting shafts are deployed to be close to a lower side of a bottom of the windshield glass.

In a wiper system for vehicles according to the present invention, a link member and a lever are integrally formed to form one third link member to save components and enhance operational reliability, an upper end portion, an intermediate portion, and a lower end portion of the third link member are integrally bent with difference heights to increase support stiffness without significant deformation on hinge shafts, the third link member allows a support shaft for mounting a passenger's seat wiper arm on an end that extends from a hinge to expose only support shafts for driver's seat and passenger's seat wider arms to be exposed, and other components can be deployed below a windshield glass, thereby simplifying an exterior while increasing a wiper brushing area.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view illustrating a schematic structure of a wiper system in the related art.

FIG. 2 is an exploded perspective view of a support shaft, a lever member, and a link member for mounting a wiper arm of FIG. 1.

FIG. 3 is a schematic plan view of an exemplary wiper system according to the present invention.

FIG. 4 is a partial perspective view illustrating a bent structure of a third link member according to the present invention.

FIG. 5 is a cross-sectional view of the support shaft fixed to the third link member according to the present invention.

FIG. 6 is a schematic cross-sectional view illustrating a state in which the exemplary wiper system of FIG. 3 is installed below a wind glass.

FIG. 7 is a schematic operation explanatory diagram illustrating an operation of the exemplary wiper system according to the present invention.

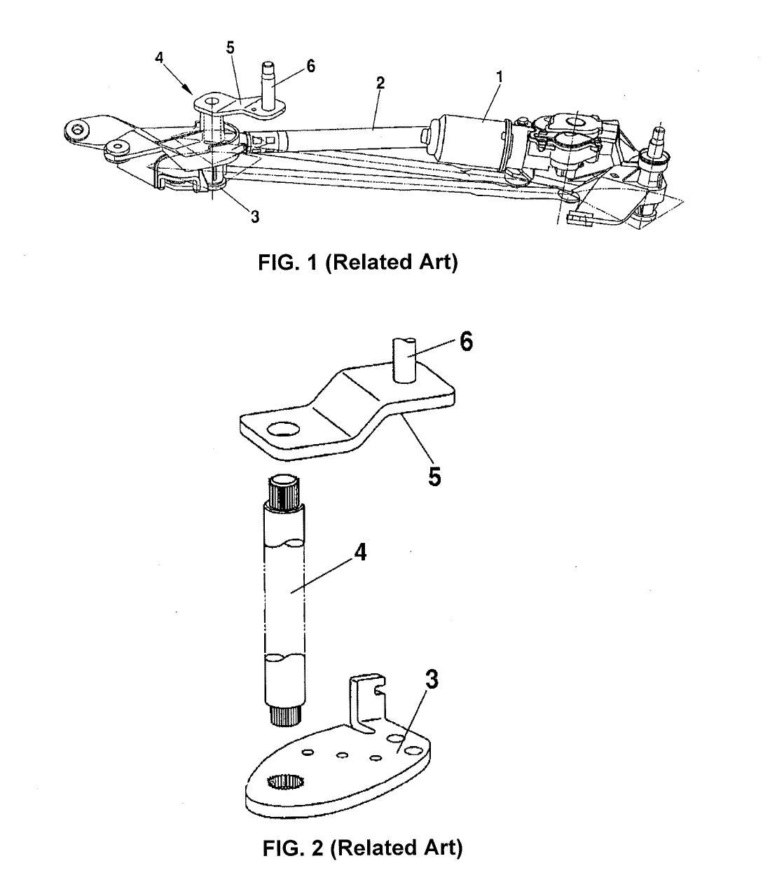

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

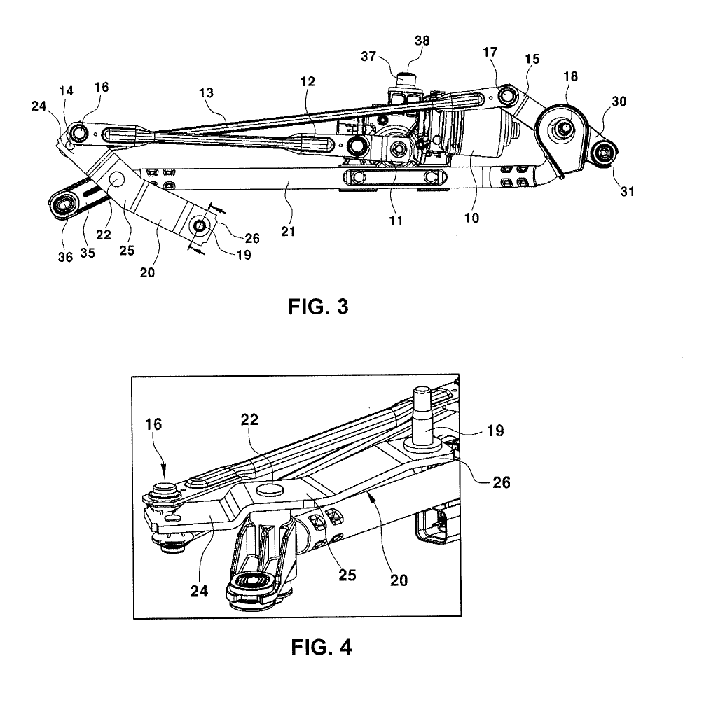

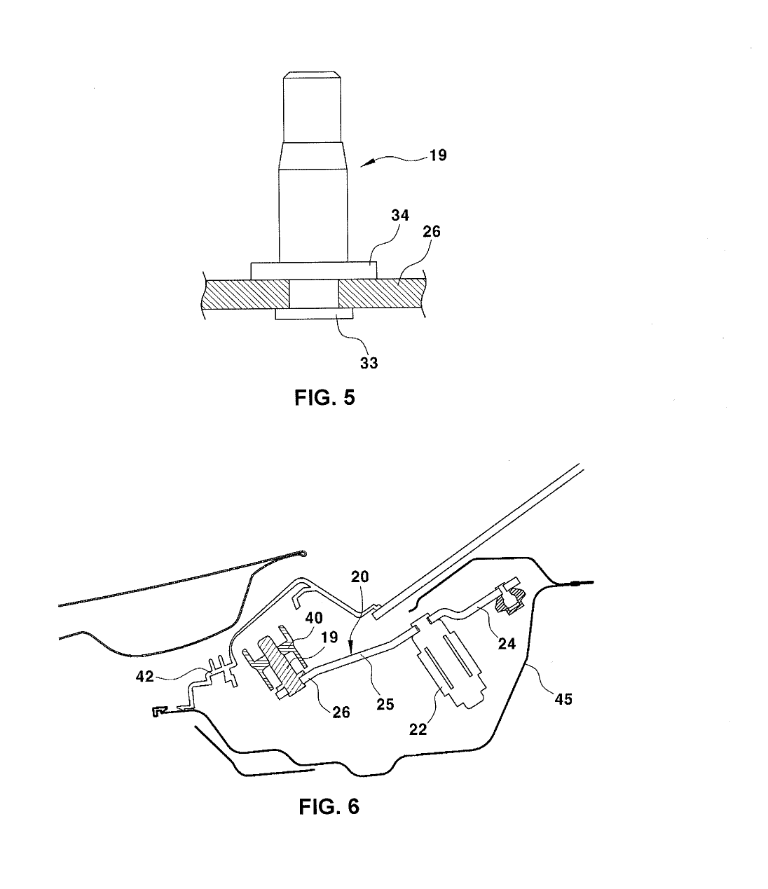

In FIG. 3, a wiper system of the present invention includes a wiper driving motor 10, a crank arm 11 that rotates with one end connected to an output shaft of the driving motor, a first link member 12 connected to the other end of the crank arm 11 to swing in a predetermined angle range by rotational movement of the crank arm 11, a second link member 13 that swings in a horizontal direction in the drawing in link with the swing of the first link member, a lever member 15 in which one end is connected to a third hinge 17 provided on a free end of the second link member and a driver's seat wiper arm mounting support shaft 18 is mounted on the other end to be connected to pivot the driver's seat wiper arm mounting support shaft in link with the first link member 12, and a third link member 20 in which the first link member 12 is connected to the top through a first hinge 16 and the second link member 13 is connected on the bottom through a second hinge 14 and a support shaft 19 for mounting a passenger's seat wiper arm linked with the first link member 12 is provided.

The third link member 20 pivots around a fourth hinge 22 with an upper end portion 24 being pivotably connected to the first hinge 16 and the fourth hinge 22 being provided as a pivot center shaft of the third link member 20 at a middle portion 25 therebelow. A lower end portion 26 of the third link member 20 extends from the fourth hinge 22 and the support shaft 19 on which the passenger's seat arm is pivotably mounted is fixed to the lower end portion 26.

According to the present invention, a fixation position of the support shaft 19 in the third link member 20 further extends downward from the fourth hinge 22 in FIG. 3, and as a result, a rotary moment from the first hinge 16 increases as compared with the case in which the support shaft is fixed to the fourth hinge 22, thereby improving a cleaning capability of a passenger's wiper.

In the third link member 20, the upper end portion 24 connected with the second hinges 16 of the first link member 12 and the second link member 13, the middle portion 25 connected with the fourth hinge 22 connected with a connection bar 21, and the lower end portion 26 with the support shaft 19 on which the passenger's seat wiper arm is mounted are formed as one component in which three portions are integrally molded, when the wiper system is viewed from the side and further, as illustrated in FIG. 4, the upper end portion 24, the middle portion 25, and the lower end portion 26 are bent at predetermined different heights. The upper end portion 24 at which the first hinge 16 is provided is positioned at a lowest location, the middle portion 25 at which the fourth hinge 22 is provided is positioned thereabove, and the lower end portion 26 at which the support shaft 19 is provided is positioned at a highest location.

The support shafts 18 and 19 that support the driver's seat wiper arm and the passenger's seat wiper arm that need to clean another curved portion of a windshield glass formed by a curved surface in overall, respectively are not deployed parallel to each other in actuality. Nevertheless, the upper end portion 24, the middle portion 25, and the lower end portion 26 of the third link member 20 are bent at predetermined different heights in order to adjust the heights of movement planes of the link members so that the crank arm 11 and the upper end portion 24 of the third link member 20 move on the same plane as possible or at least a closed plane and further, the lever member 15 for pivoting the driver's seat wiper arm support shaft 18 and the middle portion 25 of the third link member 20 that pivots around the hinge 22 to pivot the passenger's seat wiper arm support shaft 19 moves on the same plane as possible or at least the closed plane, so as to prevent an excessive angle displacement at the first and third hinges 16 and 17 of the first link member and the second link member linked together with the crank arm 11 driven by the motor.

Further, the third link member 20 has the bent structure as described above and stiffness thus increases to thereby provide sufficient support force with respect to the passenger's seat wiper arm support shaft 19.

The upper end portion 24, the middle portion 25, and the lower end portion 26 of the third link member 20 are designated based on locations viewed in FIG. 3 and actually, the upper end portion 24, the middle portion 25, and the lower end portion 26 may have a bent shape with the heights being increased in the order of the upper end portion, the middle portion, and the lower end portion as illustrated in FIG. 4.

However, the bent shape is not absolute and although not illustrated, the middle portion 25 at which the fourth hinge 22 is provided is positioned below the upper end portion 24 at which the hinge 16 is provided and the lower end portion 26 at which the support shaft 19 is provided is deployed at the highest location, and as a result, the upper end portion 24, the middle portion 25, and the lower end portion 26 of the third link member 20 may be bent unlike FIG. 4 so as to prevent the upper end portion 24, the middle portion 25, and the lower end portion 26 of the third link member 20 from interfering with each other.

In the support shaft 19, a fixation end portion 33 penetrates the lower end portion 26 of the third link member 20, a support portion 34 of which a diameter is enlarged is formed at a position spaced inside from the fixation end portion by the thickness of the third link member 20, and the support portion 34 is deployed on the top of the third link member 20 and the fixation end portion 33 penetrating the third link member 20 is fixed to the third link member 20 by hitting in a general rivet fixation scheme. As such, by the support shaft 19 being strongly fixed to the third link member 20, it is possible to solve a problem of a wiper system in the related art, in which since a support shaft may swing due to a gap generated between the support shaft and a hole of a link member with a usage period that elapses, a wiper arm swings while operation, and as a result, a cleaning effect deteriorates.

The wiper system of the present invention is fixed to a cowl box of a vehicle body. That is, each of an end portion 31 of a bracket 30 to which the support shaft 18 on which the driver's seat wiper arm is mounted is pivotably connected, an end portion 36 of a bracket 35 connected with the connection bar 21 at the middle portion of the third link member 20 and to which the hinge 22 is pivotably connected, and an end portion 38 of a bracket 37 connected to the driving motor 10 is fixed into the cowl box and to a lower side of the windshield glass. One end of the connection bar 21 is connected to the bracket 30 for the driver's seat arm support shaft 18 and the other end is connected to the bracket 35 penetrated by the fourth hinge 22 of the third link member 20.

That is, as illustrated in FIG. 6, most components of the driving motor positioned at the upper end portion 24 and the side of the middle portion 25 of the third link member 20, that is, all of the first and second link members 12 and 13 and the lever member 15 including the fourth hinge 22 are deployed in a cowl panel 45 at the lower side of the windshield glass, while only the driver's seat and passenger's seat wiper arm mounting shafts 18 and 19 are deployed to be close to a lower side of the bottom of the windshield glass, and as a result, a cleaning area of the windshield glass by a wiper is increased and a front exterior of the vehicle is improved to be simpler. In the drawing, undescribed reference numeral 40 represents a head of the passenger's seat wiper arm mounted on the support shaft 19 and reference numeral 42 represents a cowl top cover.

The wiper system of the present invention having the structure is driven as below.

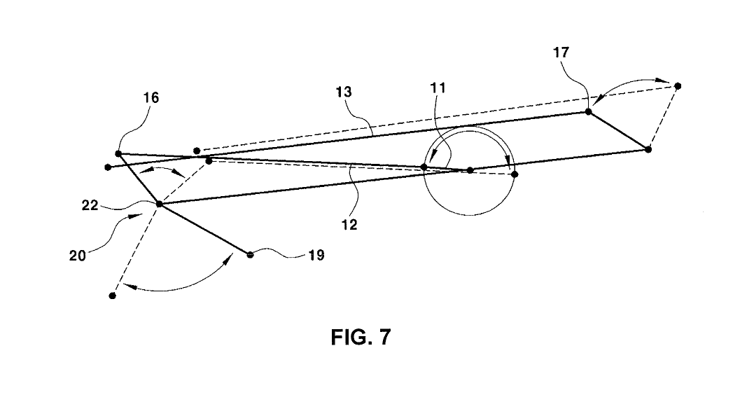

In FIG. 7, as the crank arm 11 rotates at 180° at an opposite side to the location illustrated in FIG. 3, the first link member 12 moves rearward with a distance corresponding to a rotational radius of the crank arm 11, and as a result, the first hinge 16 connected with an end portion of the first link member 12 on the top of the upper end portion of the third link member 20 rotates clockwise around the fourth hinge 22 of the third link member 20. Therefore, while the second link member connected through the second hinge 14 on the bottom of the upper end portion of the third link member moves to the left in the drawing, as the lever member 15 pivots clockwise, the support shaft 18 of the driver's seat wiper arm rotates clockwise, thereby achieving a cleaning operation of a driver's seat wiper. In this case, the third link member 20 connected to the first hinge 16 also rotates around the fourth hinge 22 and the passenger's seat wiper arm support shaft 19 of an end portion thereof pivots, and as a result, a passenger's wiper performs the cleaning operation while rotating clockwise.

Then, when the crank arm 11 rotates at 180° to 360°, the first link member 12 moves in an opposite direction to the aforementioned direction to move forward to an initial location again and as the first hinge 16 pivots counterclockwise around the fourth hinge 22, the second link member 13 connected to the second hinge 14 at the upper end portion of the third link member 20 moves to the left in the drawing and the lever member 15 connected thereto and the support shaft 18 of the driver's wiper arm rotates counterclockwise to an initial position and further, as the third link member 20 connected to the first hinge 16 rotates counterclockwise around the fourth hinge 22, while the passenger's seat wiper arm support shaft 19 fixed to the end portion of the third link member 20 rotates counterclockwise, the passenger's seat wiper also rotates to an original location. As a result, one cleaning operation of the driver's seat and passenger's seat wipers is completed and the process is repeated, and as a result, a wiper of the vehicle operates.

According to the present invention, in the third link member 20, the passenger's driver wiper arm support shaft 19 is provided at the lower end portion 26 that extends to a lower side of the hinge 22 of a pivot center below the first hinge 16 connected with the first link member and a distance from the first hinge 16 increases as compared with the passenger's seat wiper arm support shaft is formed at the fourth hinge 22 and rotated by a separate lever member in the related art and a rotary moment of the third link is thus further increased, and as a result, the cleaning capability of the passenger's seat wiper is further increased to easily remove snow or foreign substances laid on window glass and further, the third link member 20 has the bent structure, and as a result, stiffness is increased. Therefore, a problem such as deformation of the link member in the related art does not occur.

Further, the wiper system of the present invention is generally deployed at the lower side of the window glass, the driver's seat wiper arm support shaft 18 and the passenger's seat wiper arm support shaft 19 are deployed to be close to a lower end of the window glass to minimize a part exposed to the outside, thereby clearly arranging the front exterior of the vehicle and the fourth hinge 22 of the third link member 20 that pivots the passenger's seat wiper arm support shaft 19 is deployed at the lower end of the glass or to be maximally close thereto to extend the wiping area of the window glass by the passenger's seat wiper arm, thereby providing a wider and cleaner view and improving the exterior of the wiper arm.

The wiper system of the present invention can be applied to increase the cleaning capability of the wiper and improve the exterior without significantly changing the existing structure.

For convenience in explanation and accurate definition in the appended claims, the terms “upper” or “lower”, “inner” or “outer” and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A wiper system for motor vehicles, the system comprising:
a crank arm configured to be rotated by a wiper driving motor;
a first link member connected to a first end of the crank arm to be linked with the crank arm;
a third link member connected through a first hinge to be linked with the first link member and a second link member of which a first end is connected to the third link member through a second hinge;
a lever member in which a first end is pivotably connected to a third hinge provided at a second end of the second link member and a driver's seat wiper arm mounting support shaft is pivotably provided at a second end; and
a support shaft for mounting a passenger's seat wiper arm provided at a first end of the third link member of which one end is connected to the first hinge,
wherein the third link member is integrally formed to include an upper end portion connected with the first link member linked with the crank arm through the first hinge, a middle portion connected to a first bracket through a fourth hinge as a pivot center shaft, and a lower end portion to which the passenger's seat wiper arm support shaft is fixed.

2. The wiper system of claim 1, wherein in cleaning operations of a driver's seat wiper and a passenger's seat wiper that clean a curved portion of a windshield glass formed by a curved surface, the upper end portion, the middle portion, and the lower end portion are configured to be bent at predetermined different heights in order to adjust a height of a movement plane so that the upper end portion, the middle portion, and the lower end portion of the third link member move on a plane on which the crank arm and the upper end portion of the third link member are at least close and the middle portion that pivots around the hinge moves on a plane at least close to the lever member so as to prevent an excessive angle displacement at the first and third hinges of the second link member and the third link member.

3. The wiper system of claim 1, wherein in the third link member, the support shaft on which a passenger's seat arm is pivotably mounted so as to increase a rotary moment around the first hinge provided on a top is provided at a location that extends from the fourth hinge of the middle portion.

4. The wiper system of claim 1, wherein in the support shaft, a fixation end portion penetrates the third link member, a support portion of which a diameter is enlarged is formed at a position spaced inside from the fixation end portion by a thickness of the third link member, and the support portion is configured to be deployed on a top of the third link member and the fixation end portion penetrating the third link member is fixed to the third link member in a rivet fixation scheme.

5. The wiper system of claim 2, wherein in the third link member, the upper end portion at which the first hinge is provided, the middle portion at which the fourth hinge as a rotational center shaft is provided, and the lower end portion with the support shaft on which the passenger's driver wiper arm is mounted are configured to be sequentially bent with heights being increased.

6. The wiper system of claim 2, wherein the third link member is bent so that the middle portion at which the fourth hinge is provided is positioned below the upper end portion at which the first hinge is provided and the lower end portion at which the support shaft is provided is configured to be deployed at a highest location.

7. The wiper system of claim 1, wherein the first and second link members including and the lever member are configured to be deployed in a cowl box below a windshield glass, while the driver's seat and passenger's seat wiper arm mounting shafts are deployed to be close to a lower side of a bottom of the windshield glass.
